(19) United States
(12) Patent Application Publication
(10) Pub. No.: US 2025/0313181 A1
(43) Pub. Date: Oct. 9, 2025

(54) BRAKE UNIT FOR MOUNTING ON A WHEEL OF A MOTOR VEHICLE

(71) Applicant: Robert Bosch GmbH, Stuttgart (DE)

(72) Inventors: Martin Hagspiel, Rettenberg (DE); Andreas Weh, Sulzberg (DE)

(21) Appl. No.: 18/863,449

(22) PCT Filed: Oct. 13, 2023
(86) PCT No.: PCT/EP2023/078474

§ 371 Date: Nov. 6, 2024

(30) Foreign Application Priority Data
Dec. 22, 2022 (DE) 10 2022 214 269.1

(51) Int. Cl. B60T 11/10; B60T 17/22

(52) U.S. Cl. CPC B60T 11/10; B60T 17/221

(57) ABSTRACT

A brake unit for mounting on a wheel of a motor vehicle including an axially movable brake element and a drive device which selectively moves the brake element axially. The brake element is configured as an axially movable brake piston that is coupled to the drive device in a force-transmitting manner by means of a hydraulic transmission.

### FIELD

The present invention relates to a brake unit for mounting on a wheel of a motor vehicle, comprising an axially movable brake element and a drive device which selectively moves the brake element axially. The present invention also relates to the use of such a brake unit in a motor vehicle.

### BACKGROUND INFORMATION

In motor vehicles, such as motorcycles, cars or trucks, the use of a central hydraulic brake unit, typically disposed in an engine compartment of the motor vehicle, is well-known. The central brake unit includes a hydraulic unit that is hydraulically connected to a brake pedal actuated by a driver. When the brake pedal is actuated, a piston that is conventionally guided in a master brake cylinder is moved such that a mechanical pressure of the brake pedal is transferred to a hydraulic system of the brake unit. Brake fluid present there is hydraulically conveyed to a wheel brake of at least one associated wheel by means of a volume displacement through a brake line. This provides brake pressure at the wheel.

Specifically, at least one piston disposed in a brake caliper is provided as an axially movable brake element in the wheel brake on the wheel. The piston is moved by the brake pressure in the direction of a radially movable friction element that is attached to the wheel. A brake disc or brake drum is an example of such a friction element. The piston pushes against a brake pad that is pressed against the friction element. This produces a frictional force that brakes the rotational movement of the friction element and the wheel coupled to it. When the pressure is released the piston moves back into the brake caliper. The braking operation is terminated.

In modern brake systems comprising such a central hydraulic brake unit, the brake pedal with the master brake cylinder often serves in normal operation only to detect the driver's braking request. The master brake cylinder is decoupled from the wheel brakes. Brake pressure at the associated wheel brakes, on the other hand, is produced by means of a pressure medium from an electrically controllable pressure build-up device. The brake system can usually be operated at a hydraulic fallback level with pressure medium from the master brake cylinder. Such a brake system is described in German Patent Application No. DE 10 2014 222 759 A1. For normal braking, a braking request is forwarded to the electrically controllable pressure build-up device by means of an electrical signal. The brake pedal is no longer directly connected to the brake unit.

Newer vehicle developments with increasing levels of automation do without the brake pedal altogether. This places new demands on the brake system and creates possibilities for the brake system. Thus, it is conventional to provide an electromechanical brake directly on the wheel as a brake unit which typically comprises an electric motor as a converter of electrical energy to mechanical energy. The mechanical energy is used to press an axially movable brake element as a ram against the radially movable friction element. This necessitates a high transmission ratio between the converter and the brake element to achieve the required braking force.

It is an object of the present invention to provide a brake unit which is optimized in terms of force and installation space, in particular for newer vehicle developments, and which also enables particularly safe and long-lasting braking operation.

### SUMMARY

According to the present invention, a brake unit for mounting on a wheel of a motor vehicle or a wheel brake brake unit is provided. According to an example embodiment of the present invention, the brake unit includes an axially movable brake element and a drive device which selectively moves the brake element axially. The brake element is configured as an axially movable brake piston that is coupled to the drive device or an actuator in a force-transmitting manner by means of a hydraulic transmission. The brake piston is in particular guided in an axially or translationally movable manner in an associated piston housing or brake housing. Preferably, brake fluid can be or is accommodated in the brake housing as a pressure medium as well. The brake piston is guided in an axially movable manner in the brake housing by means of a volume displacement of the brake fluid. Such a brake piston can be moved with significantly less force than an axially movable brake element, such as a ram of a conventional electromechanical brake unit. In particular, significantly lower frictional forces of the involved components have to be overcome.

The hydraulic transmission moreover increases a transmission ratio between the drive device and the brake piston considerably compared to a conventional electromechanical brake unit. As a result, and in combination with the brake element configured as a brake piston, the required loads and acting forces in the brake unit and in the brake system overall are significantly lower. Simpler and more cost-effective components can be used while at the same time achieving a longer service life.

According to an example embodiment of the present invention, the brake piston preferably comprises an end face that can be guided out of the brake housing by means of the drive device. As it moves out of the brake housing, the brake piston exerts a pressing pressure in axial direction on a friction element attached to the wheel. On the end face positioned in this way on the outside, there is preferably a pressing element, in particular like a brake jaw, to which a brake pad that is to be pressed against the friction element is particularly preferably attached. When the pressure exerted on the brake piston by means of the drive device decreases, the brake piston moves back into the brake housing and the brake piston is no longer pressed against the friction element. The braking action is terminated. The friction element is structurally simple, preferably a brake disc, or transmits force very well, preferably a brake drum.

According to an example embodiment of the present invention, the drive device is also preferably coupled to an electrical control device or an electrical control unit in a signal-transmitting manner. The electrical control device is adapted to acquire a braking request from the driver or, in the case of automated driving, a need for braking from an associated vehicle control system, and forward it accordingly to the drive device. The drive device is supposed to set the brake piston into an associated translational movement in accordance with the braking request.

With such a brake unit according to the present invention, an in particular self-contained hydraulic unit for mounting directly on the wheel of a motor vehicle is created. This closed wheel brake brake unit with hydraulic transmission is thus a single, decentralized brake unit, which is to be mounted on the wheel and in particular represents an electrohydraulic brake. For particularly uniform, easily controllable, adaptable and redundant braking, it is preferred to have at least two such brake units and it particularly preferred to have one such decentralized brake unit per wheel. Unlike a conventional central hydraulic brake unit, none of the decentralized brake units take up space in the engine compartment. There is also no need for brake lines from the engine compartment to the respective wheel brakes. This saves material and valuable installation space.

According to an example embodiment of the present invention, the hydraulic transmission is advantageously configured using a drive piston, which is provided in addition to the brake piston and is guided in an axially movable manner in a drive housing in which brake fluid can be or is accommodated. The drive piston can be moved hydraulically by means of the brake fluid, with which the brake piston, too, can be moved hydraulically. The brake piston can be moved out of its brake housing in particular by means of the brake fluid, whereas the drive piston can be moved into its drive housing. Such a hydraulic transmission that uses two pistons is especially energy-saving. There is in particular very little friction loss. Overall, this further reduces the load requirements on the components involved.

According to an example embodiment of the present invention, the drive piston furthermore advantageously has a drive piston diameter and the brake piston has a brake piston diameter which differs from the drive piston diameter. This enables a hydraulic transmission to be varied as needed and adapted appropriately to the respective requirements.

The brake piston diameter is preferably larger than the drive piston diameter. The hydraulic transmission is thus implemented in such a way that the larger brake piston diameter allows a greater force to be exerted by the brake piston on the friction element than can be transmitted from the gearing to the drive piston at approximately the same pressure in the brake fluid. With such a hydraulic transmission, a comparatively high braking force is transmitted from the brake piston to the friction element during a braking operation with a comparatively small amount of force from the drive piston.

According to an example embodiment of the present invention, the drive piston is advantageously configured such that it can selectively be moved into the drive housing and moved back out of the drive housing by means of the drive device. The drive piston can thus be actively moved back and forth as needed by means of the drive device. To build up pressure by means of the brake piston, the drive piston has to actively be pushed into the drive housing in a drive direction and the brake piston thus has to be pushed out of the brake housing. To reduce pressure or to relieve pressure, the drive piston has to actively be retracted against the drive direction by means of the drive device. At the same time, the brake piston, too, is retracted by means of the hydraulic coupling and the braking operation is terminated. The drive device is preferably configured with a structurally simple spindle drive that is connected to the drive piston.

According to an example embodiment of the present invention, the drive piston is alternatively or additionally advantageously configured such that it can be moved against a drive direction by means of a spring element. After the drive piston has been moved in drive direction into the drive housing, the spring element acts with its deformation force to reset the drive piston. After a force acting from the drive device in drive direction is removed, the drive piston is pushed back against the drive direction by means of the spring element. The brake piston, too, is reset by means of the hydraulic coupling. The spring element thus acts as a return spring. The spring element is preferably cost-effectively a mechanical spring element, particularly preferably a metallic spring element such as a helical spring or compression spring. Alternatively or additionally, the spring element is preferably configured with an elastomer. The spring element is furthermore preferably structurally simply a single return element which acts on the drive piston. The spring element is particularly preferably provided in addition to a drive device that resets the drive piston. Thus, even in the event of a malfunction, such as a failure of the drive device during the braking operation, for example due to a power failure, the spring element resets the drive piston and thus retracts the brake piston. This prevents residual pressure from remaining in the system due to friction.

According to an example embodiment of the present invention, the drive device advantageously also comprises a drive motor or motor and a transmission that can be driven by said motor. The motor can preferably be controlled by an electrical control unit and is particularly preferably configured as an electric motor. Thanks to the hydraulic transmission, the electric motor can in particular be configured with a relatively low torque. The installation space and use of material required by such a motor is very small. Thus, in particular valuable raw materials such as copper and magnets can be saved.

According to an example embodiment of the present invention, the transmission is preferably configured with a rotational-mechanical gear ratio. A torque of a rotational movement of a motor element, such as a motor shaft, is first converted by means of a mechanical transmission into a higher torque of a rotational movement of the gearing. The torque of the motor is thus initially transmitted rotation to rotation. For this purpose, the gearing comprises a rotary part, which can be configured in different embodiments. The rotary part is preferably configured as a planetary gear, a spur gear or a worm gear. This is followed by a rotation to translation transmission by means of a translation part that belongs to the gearing and is preferably configured as a ball screw drive or particularly preferably as a spindle-nut drive. The thus generated translational movement sets the brake piston, which is hydraulically coupled to the gearing, into a translational movement. The drive piston, which can be set into an axial movement by means of the gearing, is preferably positioned between the brake piston and the gearing. Such types of gears are simple and space-saving in terms of their design, which saves installation space and materials. It has been found that such a simple mechanical transmission in the drive device in combination with the hydraulic transmission between the drive device and the brake piston makes it possible to ensure an energy-saving and reliable build-up of brake pressure.

According to an example embodiment of the present invention, the gearing is preferably is configured with a ball screw drive. A spindle is surrounded by a thread on which at least one nut is provided, in which balls rotate in a closed system. This creates a rolling friction that, compared to sliding friction in a spindle-nut drive or spindle drive, reduces friction losses. The gearing is particularly preferably configured with the more cost-efficient spindle drive or spindle drive, however. A rotational movement generated by the motor is transmitted by means of a coupling to a spindle or to a nut or spindle nut that engages in a thread of the spindle, so that the rotational movement can be converted into a linear movement by means of the spindle nut. This creates a structurally very simple, cost-efficient and precise drive that requires comparatively few individual components. With correspondingly few individual components, there is correspondingly little play in the gearing, which increases its accuracy and service life.

Furthermore, according to an example embodiment of the present invention, a pressure compensation device is advantageously provided, which is in particular hydraulically connected to the drive device. For this purpose, a fluid line is preferably disposed between the drive device and the pressure compensation device. The fluid line in particular connects the drive housing to a pressure compensation reservoir. Brake fluid can be or is accommodated in both the drive housing and the pressure compensation reservoir. The pressure compensation device is thus used for the compensatory storage of brake fluid in an overall closed hydraulic system of the brake unit. There is otherwise a risk in the closed hydraulic system that unwanted braking force is produced as a result of heating and an associated increase in pressure. In the event of such heating, the pressure compensation device enables thermal volume compensation, which prevents the occurrence of such an unwanted braking force.

According to an example embodiment of the present invention, the fluid line is preferably disposed in a region of the drive housing in which the drive piston is located when it is in the rest position. The fluid line is configured as a so-called shifting bore. A fluid-conducting connection or separation of the pressure compensation device, which is established depending on the position of the drive piston, is preferably created by means of a special geometry on the drive piston. The special geometry is particularly preferably provided on an end face of the drive piston facing in drive direction. For this purpose, the drive piston in particular comprises a groove on its end face that, in its rest position, is disposed in the region of the fluid line. Thus, a connection between a hydraulic region, in particular the drive housing, and the pressure compensation device is provided. This enables pressure equalization in the brake fluid. When the drive piston is pushed with its end face into the drive housing, the fluid line is preferably closed by the drive piston which then rests with its entire periphery against the drive housing. Alternatively, the drive piston preferably does not rest with its entire periphery against the drive housing and is instead provided with a sealing arrangement that radially surrounds the drive piston. With the fluid line closed in this way, a brake pressure that is not affected by the pressure compensation device is built up in the direction of the brake piston. According to the present invention, the pressure compensation device is preferably configured with a pressure compensation membrane, which is in particular sealingly disposed in the pressure compensation reservoir. This creates a sealed separation between atmospheric air pressure and the brake fluid in the drive housing, which also reacts particularly flexibly to pressure changes.

To seal the hydraulic region from its surroundings, a seal is preferably provided on the brake piston, which radially surrounds the brake piston and is in particular configured as a sealing ring. Particularly preferably, two such seals are disposed axially one after the other on the brake piston. This ensures increased safety against leakage.

According to an example embodiment of the present invention, a first sensor coupled to the drive device and a second sensor are advantageously provided as well. The second sensor is preferably coupled to the brake piston. The second sensor is particularly preferably coupled to a brake chamber disposed in the brake housing in drive direction in front of the brake piston. Alternatively, preferably, the second sensor is coupled to a pressure chamber associated with the drive device in the drive housing. A required braking force can thus be ascertained using different methods. The sensors are preferably configured as pressure and/or force sensors. A calculation using a motor current or a motor position, which can be determined via a rotor position sensor, is moreover preferred. The two sensors are in particular coupled in a signal-transmitting manner to a control unit, which controls the drive device, and there in particular the motor, depending on the signal.

The first sensor is particularly preferably configured as a rotor position sensor and the second sensor is in particular configured as a pressure sensor. This creates a redundancy in the ascertainment of the braking force by the rotor position sensor on the drive motor and by the pressure sensor in the hydraulic transmission. Thus different methods are used for redundancy, which makes it possible to catch a variety of failures particularly comprehensively. It is also advantageous that, due to the hydraulics, a measurement by means of a pressure sensor is very easy to implement. The engine is particularly preferably configured with a power pack that creates a connection to the pressure sensor.

The present invention is also directed toward the use of at least one such brake unit on a respective wheel or as a component of a wheel brake of a motor vehicle. Such a brake unit is preferably disposed and used on at least two wheels and particularly preferably on each wheel of the motor vehicle. The present invention is therefore also directed toward a brake system of a motor vehicle in which such a brake unit is disposed on at least one wheel of the motor vehicle. Such a brake unit is preferably disposed on each wheel of the motor vehicle with a respective associated control unit. To brake one or more wheels of the motor vehicle, an electrical signal is sent to the control unit of the respective brake unit. The control unit controls the associated motor that transmits the torque to the rotational-mechanical gear ratio, with which the brake piston is set into a translational movement by means of the hydraulic transmission.

Thus, according to an example embodiment of the present invention, at least one decentralized brake unit is advantageously used, which in particular does not take up any installation space in the engine compartment of the motor vehicle. For a particularly uniform braking effect, at least two such decentralized brake units are provided on each wheel. Particularly preferably, one such brake unit is disposed on each wheel of the motor vehicle. Thus, compared to a conventional centralized brake unit housed in the engine compartment, there is no space problem in the engine compartment. There is also no need for brake lines from the engine compartment to the respective wheel brakes. There is also no need for a second brake unit for autonomous driving, because, with the solution according to the present invention, there is in particular already a separate brake unit on each wheel. The required redundancy is preferably provided by means of at least two brake units according to the present invention, which are connected to two separate power sources.

Embodiment examples of the solution according to the present invention are explained in more detail in the following with reference to the schematic figures.

### BRIEF DESCRIPTION OF THE DRAWINGS

FIG. 1 shows a circuit diagram of a brake unit according to the related art.

FIG. 2 shows the circuit diagram according to FIG. 1 of a first embodiment example of a brake unit according to the present invention with a first drive piston variant.

FIG. 3 shows a schematic longitudinal section of the first embodiment example with a second drive piston variant.

FIG. 4 shows the circuit diagram according to FIG. 1 of a second embodiment example of a brake unit according to the present invention with the first drive piston variant,

FIG. 5 shows the view according to FIG. 3 of the second embodiment example with the second drive piston variant.

FIG. 6 shows the detail VI according to FIG. 2 in different positions of a drive piston of a third embodiment example of a brake unit according to the present invention.

FIG. 7 shows the detail VII according to FIG. 6.

### DETAILED DESCRIPTION OF EXAMPLE EMBODIMENTS

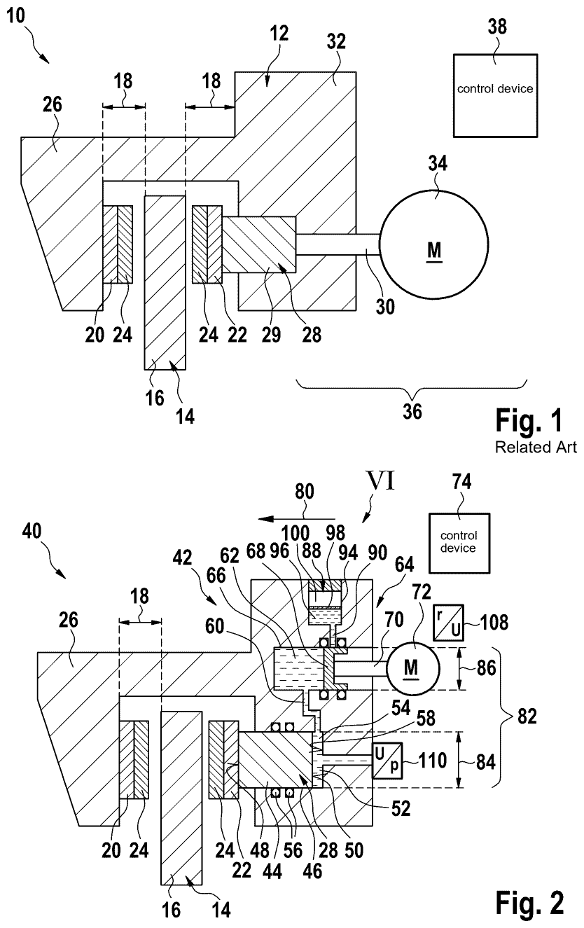

FIG. 1 shows an electromechanical brake 10 configured as a disc brake with a simplified circuit diagram. The brake 10 comprises a brake unit 12, which is disposed on a not depicted wheel of a motor vehicle. A wheel-side brake element 14 or friction element which belongs to the brake 10 and rotates during operation is attached to the wheel and is configured as a brake disc 16. The attachment is not shown. Only the brake disc 16 is partially depicted. When the wheel and the brake unit 12 are mounted on the vehicle, the brake unit 12 is disposed at the top on the radial circumference of the brake disc 16 and surrounds the brake disc 16 with a gap 18 in between.

In the gap 18 on either side of the brake disc 16 there is a respective brake shoe or brake jaw 20, 22, on the brake disc side of each of which a respective brake pad 24 is disposed. The one brake jaw 20 is mounted on a carrier element or brake caliper 26, while the other brake jaw 22 is attached to an axially movable brake element 28. The axially movable brake element 28 is configured here as a plunger 29, which can be moved back and forth in a translational manner by means of a gearing 30 in a housing 32 combined with the brake caliper 26. The gearing 30 is configured as a screw drive arrangement (not shown in more detail), which can be driven by means of a drive motor or motor 34. The motor 34 and the gearing 30 form a drive device 36, in which the motor 34 is coupled to an electrical control device 38 in a signal-transmitting manner. The motor 34 is controlled accordingly depending on the signal, which leads to a rotational movement of the motor 34. The motor 34 is coupled to the gearing 30 in such a way that the rotational movement of the motor 34 is converted into a translational movement of the plunger 29. When controlled in such a way that the plunger 29 is moved out of the housing 32 by means of the gearing 30, the brake jaws 20, 22 and thus the brake pads 24 are pressed against the brake disc 16. With the brake disc 16 as a rotating friction element, each brake jaw 20, 22 with its brake pad 24 forms a respective friction pair that brakes a rotational movement of the wheel. When the plunger 29 moves back, the brake pads 24 are released from the brake disc 16 and braking is terminated.

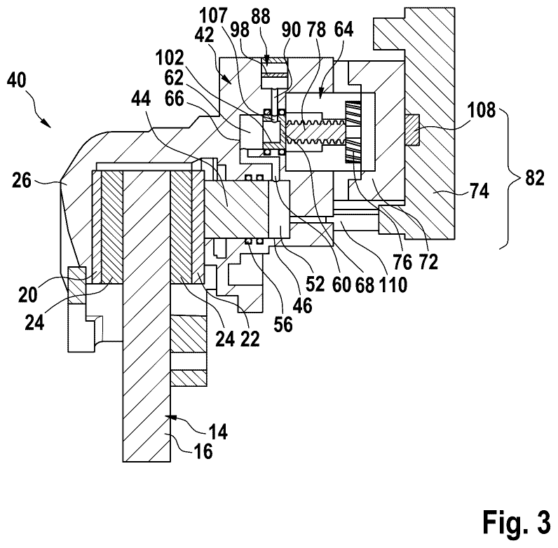

In contrast to such an electromechanical brake 10, FIG. 2 and FIG. 3 show an electrohydraulic brake 40. The brake 40 includes a brake unit 42, which comprises a brake piston 44 as the axially movable brake element 28. The brake piston 44 is guided in a translationally movable manner in a brake housing 46 disposed in the brake caliper 26. Axially outside the brake housing 46 there is an end face 48 of the brake piston 44, which is coupled to the brake jaw 22 and the brake pad 24 resting against it in a force-transmitting manner.

Axially opposite the end face 48 there is an end face 50 on the brake piston 44, which, together with the brake housing 46, encloses a brake chamber 52 of variable volume in which a brake fluid 54 is accommodated. To seal the brake chamber 52 from its surroundings outside the brake housing 46 or the brake caliper 26, two seals 56 are provided, which are disposed axially one after the other and are configured as sealing rings and each radially surround the brake piston 44. The brake chamber 52 is hydraulically connected axially between the end face 50 and a wall 58 that delimits the brake housing 46 by means of a fluid line 60 to a pressure chamber 62 filled with brake fluid 54. The pressure chamber 62 belongs to a drive device 64, which also includes a drive housing 66 that surrounds the pressure chamber 62 and a drive piston 68 that is guided in an axially movable manner in the drive housing 66.

The drive piston 68 is guided such that it can be moved axially back and forth by means of a gearing 70 that belongs to the drive device 64. The gearing 70 is coupled in a force-transmitting manner to a drive motor 72 or motor 72, which in turn is coupled in a signal-transmitting manner to a control device 74. The motor 72, which is configured as an electric motor, is controlled in terms of its rotational movement depending on the signal. Rotation in one direction sets a planetary gear 76 belonging to the gearing 70 and coupled to the motor 72 into a corresponding rotation. A spindle drive 78 which belongs to the gearing 70 and with which the rotation is converted into an axial movement of the drive piston 68 coupled to the spindle drive 78, is coupled to the planetary gear 76. When the drive piston 68 is moved into the drive housing 66 in a drive direction 80, the brake fluid 54 in the pressure chamber 62 is forced out of the pressure chamber 62 through the fluid line 60 and into the brake chamber 52. Such a volume displacement of the brake fluid 54 pushes the brake piston 44 out of the brake housing 46 with its end face 48. The brake jaw 22 disposed on the end face 48 is thus pressed with its brake pad 24 against the rotating brake element 14 on the wheel side which is configured as a brake disc 16. Rotation of the brake disc 16 and the associated wheel is braked.

When the motor 72 is driven to an opposite rotation in response to a corresponding signal, the planetary gear 76 is set in a corresponding rotation. The spindle drive 78 thus converts the opposite rotation to an opposite translational movement of the drive piston 68. The drive piston 68 is moved out of the drive housing 66 against the drive direction 80 and thus actively reset by means of the drive device 64. When resetting, the outward movement of the drive piston 68 creates suction in the pressure chamber 62, with which brake fluid 54 is drawn out of the brake chamber 52 and moved through the fluid line 60 into the pressure chamber 62. This accordingly creates suction in the brake chamber 52, with which the brake piston 44 is moved into the brake housing 46 against the drive direction 80. The brake jaw 22 disposed on the brake piston 44 is correspondingly retracted with its brake pad 24 from the brake disc 16. The braking effect is thus released.

A hydraulic transmission 82 is thus created in particular by means of the brake fluid 54, the drive piston 68 that is guided in an axially movable manner in the drive housing 66, the brake piston 44 that is guided in an axially movable manner in the brake housing 46, and the fluid line 60 that connects the two housings 46, 66. For the hydraulic transmission 82, the brake piston 44 also has a brake piston diameter 84 that is greater than a drive piston diameter 86 of the drive piston 68. The same applies to the cross-sectional diameters of the associated brake housing 46 and drive housing 66. This creates the hydraulic transmission 82, with which a relatively high braking force is transmitted from the brake piston 44 to the brake disc 16 during a braking operation with relatively little force from the drive piston 68.

The brake unit 42 is configured as a closed hydraulic system in which thermal volume compensation is made possible by means of a pressure compensation device 88 which is connected to the drive housing 66 by a fluid line 90. The fluid line 90 leads out of a region 92 of the drive housing 66, in which the drive piston 68 is disposed in its rest position, and into a pressure compensation reservoir 94. Brake fluid 54 is accommodated in the drive housing 66 and in a space 96 in the pressure compensation reservoir 94 adjacent to the fluid line 90. A pressure compensation membrane 98, which is secured in the pressure compensation reservoir 94 and delimits the space 96, sealingly separates the space 96 filled with brake fluid 54 from a space 100 filled with air pressure.

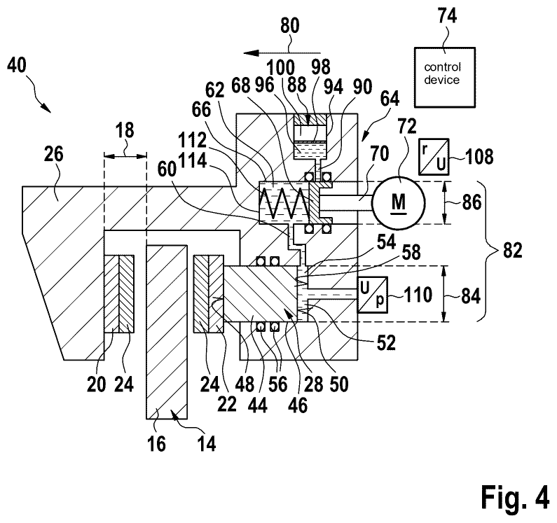

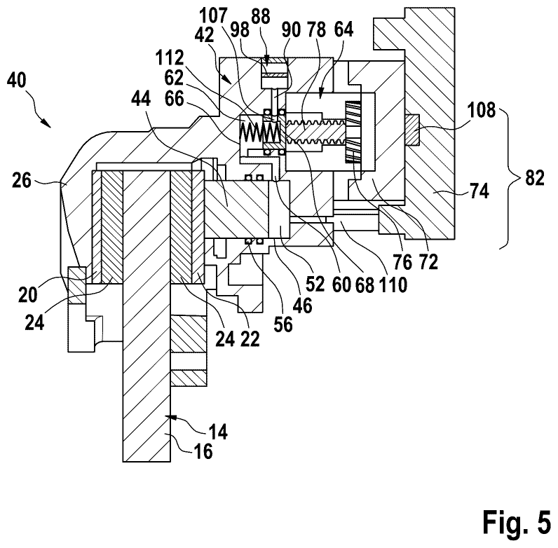

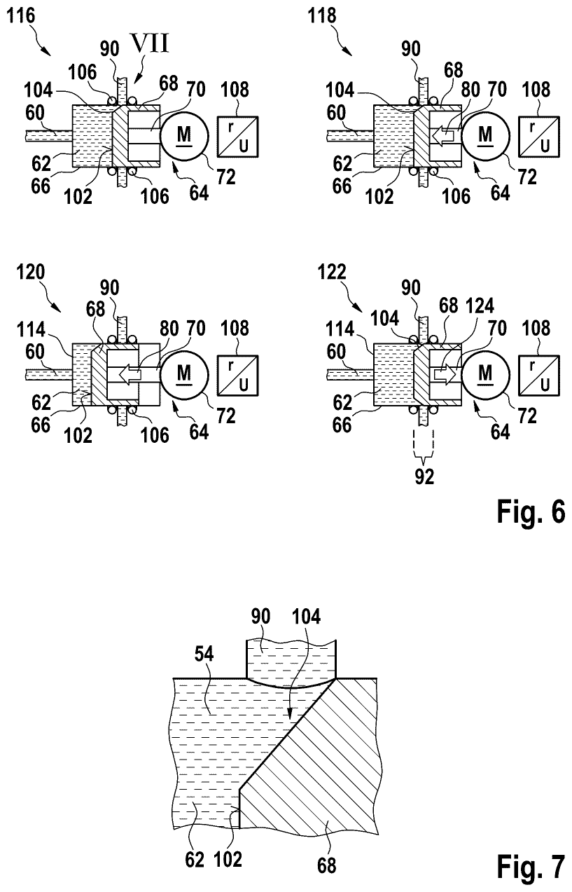

The fluid line 90 is closed or connected in a fluid-conducting manner to the drive housing 66 depending on the position of the drive piston 68. The drive piston 68 has a special design for this purpose. A first variant is shown in FIG. 2 (and FIG. 4) and a second variant is shown in FIG. 3 (and FIG. 5). According to the first variant in FIG. 2 (and FIG. 4), and also in detail in FIG. 6 and FIG. 7, the drive piston 68 has a beveled groove 104 on its end face 102 facing in the drive direction 80 which is disposed in the region 92 of the fluid line 90 in the rest position of the drive piston 68. This creates a connection between the drive housing 66 and the pressure compensation device 88. When the drive piston 68 is pushed with its end face 102 and the groove 104 disposed there into the drive housing 66, the fluid line 90 is closed because the drive piston 68 then rests with its entire periphery against the inner surface of the drive housing 66. Additional sealing is provided by a respective seal 106 disposed axially on either side of the fluid line 90 that rests radially against the drive piston 68. In a not-depicted design variant, the drive piston 68 does not necessarily rest against the drive housing 66, but only against the seal 106.

According to the second variant in FIG. 3 (and FIG. 5), the drive piston 68 comprises a through-opening 107 that leads into a cup-shaped end face 102 of the drive piston 68 that is open in drive direction 80. In the rest position, the through-opening 107 is disposed on the fluid line 90.

A first sensor 108 coupled to the motor 72 of the drive device 64 and configured as a rotor position sensor is provided for control. The sensor 108 thus acquires the rotor position of the motor 72. To provide redundancy, there is also a second sensor 110 which, as a pressure sensor, acquires the pressure of the brake fluid 54 in the brake chamber 52 of the brake housing 46. Both sensors 108, 110 are coupled to the control device 74 in a signal-transmitting manner. The motor 72, and thus the drive device 64, can be controlled with the control device 74 depending on the signal.

FIG. 4 and FIG. 5 show the electrohydraulic brake 40 in an embodiment example in which, in comparison to the embodiment example shown in FIGS. 2 and 3, a spring element 112 is disposed in the pressure chamber 62. The spring element 112 is designed as a return spring, which is configured here as a metallic helical spring. The spring element 112 is moreover disposed axially between the end face 102 of the drive piston 68 and an axially opposite wall 114 of the drive housing 66. The spring element 112 deforms when the drive piston 68 is moved into the drive housing 66 and acts to reset the drive piston 68 against the drive direction 80 when a driving force generated by the motor 72 ceases.

In the present embodiment example, the spring element 112 acts in addition to the gearing 70 that resets the drive piston 68 by means of the motor 72. Therefore, even in the event of a malfunction, such as a power failure in which the motor 72 cannot be driven, the drive piston 68 can be reset by the additional resetting effect of the spring element 112 and the brake piston 44, too, can be reset by means of the hydraulic transmission 82.

In a further advantageous embodiment not shown here, the drive piston 68 is configured to be reset solely by means of the spring element 112 as the only return element.

FIG. 6 shows different positions of the drive piston 68 in the drive housing 66. A first position 116 shows a rest position of the drive piston 68, which is shown in detail in FIG. 7 with a section. It shows the beveled groove 104 provided on the end face 102, with which a fluid-conducting connection between the fluid line 90 and the pressure chamber 62 in the drive housing 66 is created. A second position 118 of the drive piston 68 shows how the drive piston 68 is pushed into the drive housing 66 in drive direction 80 to begin to build up pressure. In a third position 120, the drive piston 68 is in its pressure build-up position, while in a fourth position 122 the drive piston 68 has been pushed out of the drive housing 66 in a direction 124 opposite to the drive direction 80 to reduce pressure.

1-10. (canceled)

11. A brake unit for mounting on a wheel of a motor vehicle, comprising:
an axially movable brake element; and
a drive device configured to selectively move the brake element axially;
wherein brake element is configured as an axially movable brake piston that is coupled to the drive device in a force-transmitting manner using a hydraulic transmission.

12. The brake unit according to claim 11, wherein the hydraulic transmission is configured using a drive piston which is provided in addition to the brake piston and is guided in an axially movable manner in a drive housing.

13. The brake unit according to claim 12, wherein the drive piston has a drive piston diameter and the brake piston has a brake piston diameter which differs from the drive piston diameter, wherein the brake piston diameter is larger than the drive piston diameter.

14. The brake unit according to claim 12, wherein the drive piston is configured such that the drive piston can selectively be moved into the drive housing and moved back out of the drive housing using the drive device.

15. The brake unit according to claim 12, wherein the drive piston is configured such that the drive piston can be moved against a drive direction using a spring element.

16. The brake unit according to claim 11, wherein the drive device includes a drive motor, and a gearing that can be driven by the drive motor.

17. The brake unit according to claim 11, wherein a pressure compensation device is provided, which is hydraulically connected to the drive device.

18. The brake unit according to claim 17, wherein the pressure compensation device is configured with a pressure compensation membrane.

19. The brake unit according to claim 11, wherein a first sensor coupled to the drive device and a second sensor are provided.

20. A method of using a brake unit, comprising the following steps:
mounting the brake unit on a wheel of a motor vehicle, the brake unit including:
an axially movable brake element, and
a drive device configured to selectively move the brake element axially,
wherein brake element is configured as an axially movable brake piston that is coupled to the drive device in a force-transmitting manner using a hydraulic transmission; and
using the brake unit on the wheel.
